(19) United States
(12) Patent Application Publication
(10) Pub. No.: US 2024/0070709 A1
(43) Pub. Date: Feb. 29, 2024

(54) Methods for dynamically forecasting engagement programs

(71) Applicant: ICF International, Inc., Fairfax, VA (US)

(72) Inventors: Nate Thompson, Blaine, MN (US); Emily Merkle, Plymouth, MN (US)

(21) Appl. No.: 18/445,467

(22) Filed: Aug. 31, 2023

Related U.S. Application Data
(60) Provisional application No. 63/402,593, filed on Aug. 31, 2022.

(51) Int. Cl. G06Q 30/0226

(52) U.S. Cl. CPC G06Q 30/0233

(57) ABSTRACT

This disclosure includes techniques for creating an engagement program forecast. The techniques include receiving customer data and transaction data for a consumer store, the transaction data being at an individual level such that individual customer's individual transactions can be seen in the transaction data. The techniques further include executing, based at least in part on the customer data and the transaction data, a loyalty forecast simulation for an engagement program for the consumer store by utilizing dynamic assumptions and developing an assumption profile for each individual customer. The techniques use the dynamic assumptions and the assumption profiles to develop a forecasted consumer profile for each respective customer over the defined time period and calculate, based at least in part on the forecasted consumer profile for each of the plurality of customers, an engagement program forecast for the engagement program.

### RELATED APPLICATIONS

This application claims the benefit of U.S. Provisional Application No. 63/402,593, filed Aug. 31, 2022, the entire contents of which are incorporated herein by reference.

### TECHNICAL FIELD

The disclosure relates to prediction models for forecasting engagement programs.

### BACKGROUND

Economic forecasting is a field of growing importance as business becomes more fast-paced in today's society. Included under this umbrella is forecasting how certain elements within a business operate and how changes could affect operations and profits for a business. This can include anything from pricing, to store layouts, to engagement programs. Engagement programs are programs offered by stores to reward customers for repeat business by allowing them to accumulate rewards, which can later be redeemed for redeemables to be used at a later date or for immediate discounts on purchases. The thought is that better rewards will mean customers do more repeat business, which can increase profits. However, rewards that are too good will lead to decreased profits. Additionally, simple purchase power for a customer may mean that they would not take advantage of better engagement programs. Creating an optimal engagement program can be a boon for business, but determining that optimal engagement program has proven to be quite difficult.

### SUMMARY

In general, the disclosure is related to techniques for forecasting different engagement programs. The techniques include receiving customer data for each of a plurality of customers of a consumer store. The techniques further include receiving transaction data for individual transactions that occur at the consumer store for each of the customers. The techniques also include executing a loyalty forecast simulation for an engagement program for the consumer store using this data. The forecast first determines an initial value for each of one or more dynamic assumptions for each respective customer. The forecast develops an assumption profile for each respective customer by, over a defined time period for the loyalty forecast simulation, adjusting the initial value for each of the one or more dynamic assumptions to generate a future value curve for each of the one or more dynamic assumptions. The forecast develops a forecasted consumer profile for each respective customer over the defined time period. With each of the forecasted consumer profiles, the techniques described herein include calculating an engagement program forecast for the engagement program.

By utilizing the dynamic assumptions, the forecast simulator described herein can predict consumer behavior at any point in time, whether the defined time period is segmented by month, week, day, hour, minute, or even second. Dynamic assumptions consider customer behavior as predicted within the simulation, adjusting future values and future behavior based on known historical behavior and what was already predicted. For instance, the simulation described herein considers a fact that a probability of a customer performing an action at any given time is not static. A customer visiting a store one day may make it significantly less likely that the customer visits the store a next day, or a customer making a purchase exceeding a certain value may make it less likely that the customer makes an additional visit for that pay period. Dynamic assumptions can adjust the probabilities of a customer performing an action based on their previous actions taken during the simulation period, thereby increasing the accuracy of the forecast. Rather than keeping a static probability throughout the simulation for large swaths of customers, the techniques described herein can drill down to a transaction level for each customer, thereby improving the simulation results.

The techniques described herein also are implemented in a practical application and provide technical benefits. For instance, the techniques described herein are specifically applied to engagement program simulations so as to not monopolize the use of adjusting probabilities throughout any simulation. Additionally, the reduced segments of time being evaluated with the dynamic assumptions greatly increase the efficiency of the processors and the overall system in calculating the forecast, as the greater number of smaller calculations are more suited for parallel processing, which reduces the stress placed on processors that would otherwise be responsible for larger, more complex calculations over longer segments of time.

In one example, the disclosure is directed to a method that includes receiving, by one or more processors and for a consumer store, customer data for each of a plurality of customers, the customer data including at least an account identification for each respective customer and consumer behavior data for each respective customer. The method further includes receiving, by the one or more processors, transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction. The method also includes executing, by the one or more processors and based at least in part on the customer data and the transaction data, a loyalty forecast simulation for an engagement program for the consumer store by, for each of the plurality of customers, determining, by the one or more processors and based at least in part on the customer data for the respective customer and the transaction data that includes the account identification for the respective customer, an initial value for each of one or more dynamic assumptions for the respective customer, developing, by the one or more processors and based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions, and developing, by the one or more processors and based at least in part on the one or more input parameters for the engagement program, the customer data for the respective customer, the transaction data that includes the account identification for the respective customer, and the assumption profile for the respective customer, a forecasted consumer profile for the respective customer over the defined time period. The method further includes calculating, by the one or more processors and based at least in part on the forecasted consumer profile for each of the plurality of customers, an engagement program forecast for the engagement program.

In another example, the disclosure is directed to a computing device for a consumer store, the computing device comprising one or more processors configured to receive customer data for each of a plurality of customers, the customer data including at least an account identification for each respective customer and consumer behavior data for each respective customer. The one or more processors are further configured to receive transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction. The one or more processors are also configured to execute, based at least in part on the customer data and the transaction data, a loyalty forecast simulation for an engagement program for the consumer store by, for each of the plurality of customers, determine, based at least in part on the customer data for the respective customer and the transaction data that includes the account identification for the respective customer, an initial value for each of one or more dynamic assumptions for the respective customer, develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions, and develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period. The one or more processors are further configured to calculate, based at least in part on the forecasted consumer profile for each of the plurality of customers, an engagement program forecast for the engagement program.

In another example, the disclosure is directed to a non-transitory computer-readable storage medium having stored thereon instructions that, when executed, cause one or more processors of a computing device for a consumer store to receive customer data for each of a plurality of customers, the customer data including at least an account identification for each respective customer and consumer behavior data for each respective customer. The instructions, when executed, further cause the one or more processors to receive transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction. The instructions, when executed, also cause the one or more processors to execute, based at least in part on the customer data and the transaction data, a loyalty forecast simulation for an engagement program for the consumer store by, for each of the plurality of customers, determine, based at least in part on the customer data for the respective customer and the transaction data that includes the account identification for the respective customer, an initial value for each of one or more dynamic assumptions for the respective customer, develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions, and develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period.

The instructions, when executed, further cause the one or more processors to calculate, based at least in part on the forecasted consumer profile for each of the plurality of customers, an engagement program forecast for the engagement program.

In another example, the disclosure is directed to a method for performing any of the techniques described herein.

In another example, the disclosure is directed to a device configured to perform any of the methods described herein.

In another example, the disclosure is directed to an apparatus comprising means for performing any of the methods described herein.

In another example, the disclosure is directed to a non-transitory computer-readable storage medium having stored thereon instructions that, when executed, cause one or more processors of a computing device to perform any of the methods described herein.

In another example, the disclosure is directed to a system comprising one or more computing devices configured to perform any of the methods described herein.

In another example, the disclosure is directed to any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a block diagram illustrating an example system including a consumer store, a point-of-sales system, and a computing device that calculates an engagement program forecast, in accordance with the techniques described herein.

FIG. 2 is a block diagram illustrating a more detailed example of a computing device configured to perform the techniques described herein.

FIG. 3 is a flow diagram illustrating an example method for calculating an engagement program forecast, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

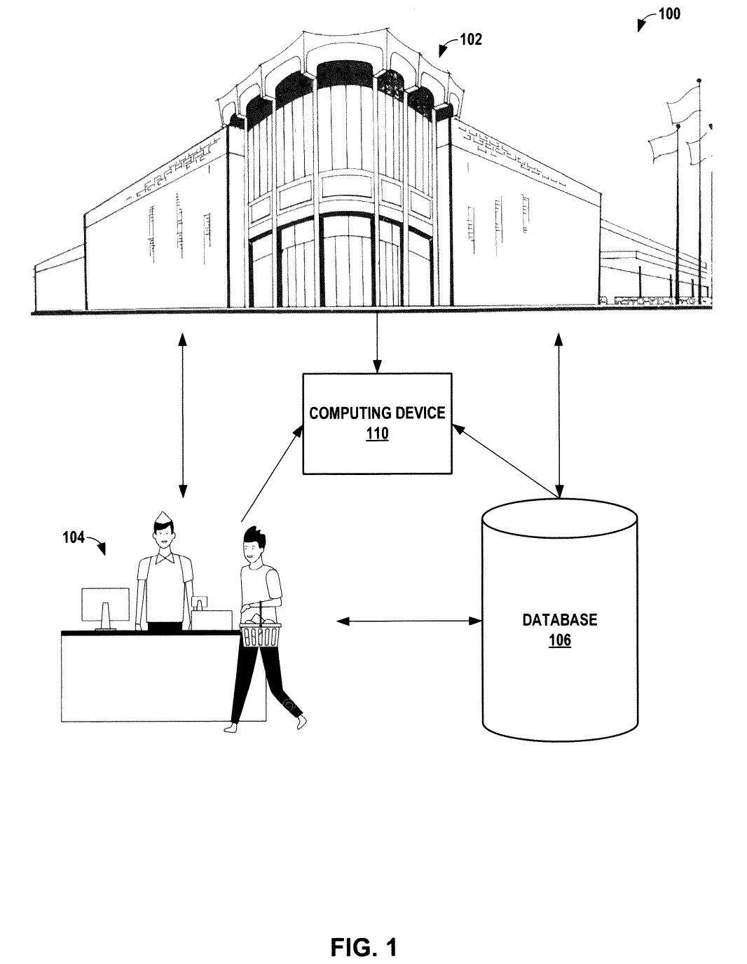

FIG. 1 is a block diagram illustrating an example system 100 including a consumer store 102, a point-of-sales (POS) system 104, and a computing device 110 that calculates an engagement program forecast, in accordance with the techniques described herein. Consumer store 102 may be any entity that sells products or services or takes donations, either in a physical brick-and-mortar location, an e-commerce platform, or both. Consumer store 102 may be either a single location store or a chain of multiple stores that all share an engagement program. Consumer store 102 may be any one or more of a retail store, a big box store, a gas station, a charity, a hotel, a bank, a school, an airline or travel service, a software application store for a mobile operating system, an ecommerce site, or any other commercial or charitable organization. Customers of consumer stores may be considered to be any one or more of donors, employees, students, account holders, product purchasers, or service purchasers, among other things. Consumer store 102 may store customer and transaction data, including information for at least a portion, potentially for all, customers who have shopped at consumer store 102, or at least customers who have registered to be a part of a store engagement program.

POS system 104 may be a physical sales system for consumer store 102, or may be the portion of an e-commerce platform that processes online transactions. POS system 104 may transmit customer data and transaction data to database 106, which may be stored locally on computing device 110, on a local storage system at consumer store 102, on a local storage system for POS system 104, or on a remote server accessible by each of POS system 104 and computing device 110.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. Computing device 110 may be in communication with at least database 106, either by storing database 106 locally, or communicating with a system that is storing database 106 either at consumer store 102 or some other remote server.

An engagement program, as described herein, includes any program where customers receive rewards, such as in the form of reward points, donation dollars, some percentage of their purchase price received back into an account, gas dollars, promotions, referrals, as a result of purchasing products, purchasing experiences, purchasing services, making referrals, subscribing to a program, purchasing a membership, or making donations, at consumer store 102. In some examples of engagement programs, the rewards can be built up over time and ultimately redeemed for redeemables, such as coupons for a percentage off a purchase, a static amount off a future purchase, a rated amount off a future purchase, merchandise, non-fungible tokens (NFTs), donations to a charity, entries into a sweepstakes, experiences (e.g., tickets to an event, a vacation, etc.), flights, hotel stays, some amount of savings on an immediate purchase, or any other benefit typically given by an engagement program. The amount of rewards used for the redeemables are then removed from the customer's account, which are built up again over time as the customer makes more purchases at consumer store 102.

Engagement programs are designed to build loyalty through rewards and personalization (e.g., knowing the customer and designing experiences around those individuals needs/wants). Engagement programs may also be designed to create repeat customers by enticing customers to spend more money at consumer store 102 by rewarding the customers for their continued patronage. The intention for consumer store 102, as with many other business ventures, are to create stronger and longer relationships between consumer store 102 and their customers, ultimately in an attempt to potentially maximize profitability for consumer store 102 or to expand consumer store 102's reach to additional customers that are acquainted with the current customer. However, engagement programs are difficult to design. If consumer store 102 does not provide adequate incentives, then customers are unlikely to change their shopping habits to frequent consumer store 102 more often or to spend more money at consumer store 102. Conversely, if consumer store 102 provides too many rewards, makes the rewards too easy to obtain, or provides too large of discounts on products or services in the rewards, then the large influx of repeat customers may produce limited profitability. The interests of consumer store 102 and the interests of the customer may be balanced in order to maximize the profitability for the store while still providing enough incentives for the customer to actually increase their spending habits.

In accordance with the techniques described herein, computing device 110 may provide this optimization by allowing a user to customize an engagement program and run a simulation that provides an engagement program forecast for how consumer store 102 can expect to profit from an engagement program with different configurations. Computing device 110 can repeat these forecasts with different settings such that the user can tweak the configurations to arrive at the optimal configuration. In doing so, computing device 110 may receive, from database 106 and for consumer store 102, customer data for each of a plurality of customers, the customer data including at least an account identification for each respective customer and consumer behavior data for each respective customer. Computing device 110 may receive, from database 106, transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction. Outputs of the engagement program forecast can include multiple predictions, including, but not limited to probabilities, per-transaction increments, or total change in various customer behavior, such as spends, frequency of reward use, frequency of shopping, and amount of reward use.

Computing device 110 may then execute, based at least in part on the customer data and the transaction data, a loyalty forecast simulation for an engagement program for the consumer store by, for each of the plurality of customers, first determining, based at least in part on the customer data for the respective customer and the transaction data that includes the account identification for the respective customer, an initial value for each of one or more dynamic assumptions for the respective customer. Computing device 110 may then develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions. Computing device 110 may then develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period. Computing device 110 may calculate, based at least in part on the forecasted consumer profile for each of the plurality of customers, an engagement program forecast for the engagement program.

By utilizing the dynamic assumptions, the forecast simulator described herein can predict consumer behavior at any point in time, whether the defined time period is segmented by month, week, day, hour, minute, or even second. Dynamic assumptions consider customer behavior as predicted within the simulation, adjusting future values and future behavior based on known historical behavior and what was already predicted. For instance, the simulation described herein considers a fact that a probability of a customer performing an action at any given time is not static. A customer visiting a store one day may make it significantly less likely that the customer visits the store a next day, or a customer making a purchase exceeding a certain value may make it less likely that the customer makes an additional visit for that pay period. Dynamic assumptions can adjust the probabilities of a customer performing an action based on their previous actions taken during the simulation period, thereby increasing the accuracy of the forecast. Rather than keeping a static probability throughout the simulation for large swaths of customers, the techniques described herein can drill down to a transaction level for each customer, thereby improving the simulation results.

The techniques described herein also are implemented in a practical application and provide technical benefits. For instance, the techniques described herein are specifically applied to engagement program simulations so as to not monopolize the use of adjusting probabilities throughout any simulation. Additionally, the reduced segments of time being evaluated with the dynamic assumptions greatly increase the efficiency of the processors and the overall system in calculating the forecast, as the greater number of smaller calculations are more suited for parallel processing, which reduces the stress placed on processors that would otherwise be responsible for larger, more complex calculations over longer segments of time.

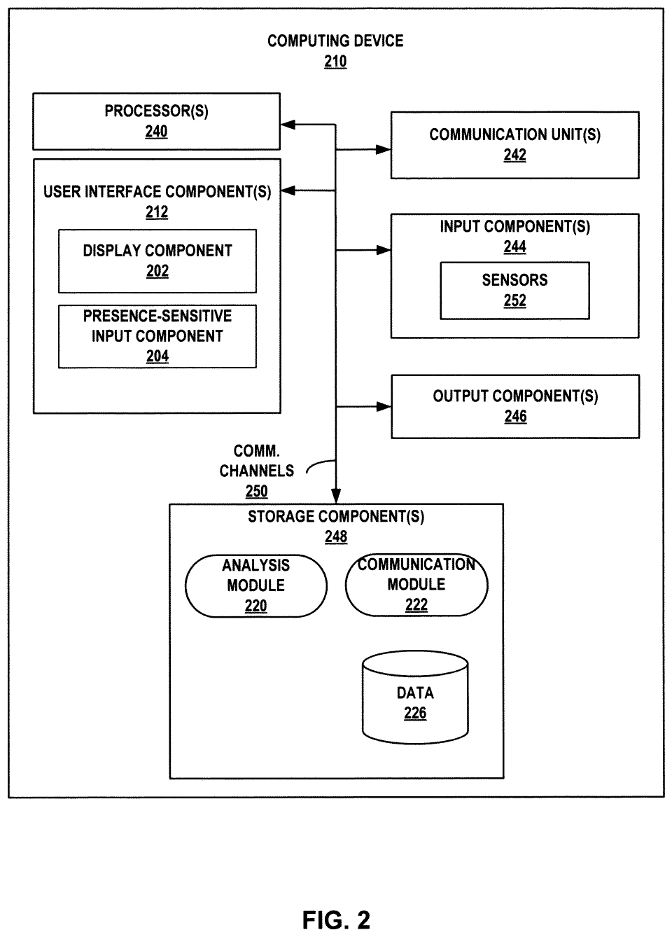

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include analysis module 220, communication module 222, and data store 226.

One or more processors 240 may implement functionality and/or execute instructions associated with computing device 210 to calculate engagement program forecasts based on transaction-level data. That is, processors 240 may implement functionality and/or execute instructions associated with computing device 210 to analyze customer and transaction data provided by a consumer store in order to create engagement program forecasts for that store.

Examples of processors 240 include application processors, display controllers, auxiliary processors, one or more sensor hubs, and any other hardware configured to function as a processor, a processing unit, or a processing device. Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to receive and analyze customer and transaction data provided by a consumer store in order to create engagement program forecasts for that store.

Analysis module 220 may execute locally (e.g., at processors 240) to provide functions associated with to analyzing customer and transaction data provided by a consumer store in order to create engagement program forecasts for that store. In some examples, analysis module 220 may act as an interface to a remote service accessible to computing device 210. For example, analysis module 220 may be an interface or application programming interface (API) to a remote server that analyzes customer and transaction data provided by a consumer store in order to create engagement program forecasts for that store.

In some examples, communication module 222 may execute locally (e.g., at processors 240) to provide functions associated with receiving customer and transaction data from a consumer store and outputting engagement program forecast data. In some examples, communication module 222 may act as an interface to a remote service accessible to computing device 210. For example, communication module 222 may be an interface or application programming interface (API) to a remote server that receives customer and transaction data from a consumer store and outputting engagement program forecast data.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality. (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, communication module 222 may receive, for a consumer store (e.g., consumer store 102), customer data for each of a plurality of customers, the customer data including at least an account identification for each respective customer and consumer behavior data for each respective customer. For instance, the customer behavior could include any one or more of a frequency that the customer shops at the consumer store, an amount that the customer spends at the consumer store, a time of year that the customer shops at the consumer store, newsletter subscription information, and department preferences within the consumer store.

Communication module 222 may receive transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction. For instance, the loyalty data may include any one or more of a percentage of the transactions where a loyalty identification was used by the customer, a frequency of the user redeeming an engagement program redeemable during a transaction, a percentage of redeemables that expire while unredeemed, an amount of a reward redeemed per transaction on average, a total number of transactions where the loyalty identification was used by the customer, a total number of transactions where the user redeemed an engagement program redeemable, a total number of redeemables that expire while unredeemed, a total amount of redeemables redeemed for the customer, a probability of the customer redeeming a redeemable during any given transaction, a probability of the customer converting rewards into a redeemable, a probability of the customer to incrementally transact to redeem a redeemable, a probability of the customer to incrementally transact after redeeming a redeemable, an incremental spend associated with redeeming a redeemable, and an incremental spend associated with a next transaction after redeeming a redeemable. Additionally or alternatively, the transaction data may be data regarding each individual transaction with each individual customer that is processed at the consumer store, such as individual transactions processed at the consumer store for each individual customer in the plurality of customers.

The customer data and transaction data may be stored in data store 226. Analysis module 220 may execute, based at least in part on the customer data and the transaction data, a loyalty forecast simulation for an engagement program for the consumer store. In executing the loyalty forecast simulation, for each of the plurality of customers, analysis module 220 may determine, based at least in part on the customer data for the respective customer and the transaction data that includes the account identification for the respective customer, an initial value for each of one or more dynamic assumptions for the respective customer. Dynamic assumptions may be a probability that a particular customer will perform a particular action at a particular point in time (e.g., particular month, particular week, particular day, particular hour, particular minute, particular second. etc.) during the defined time period based at least in part on the customer data for the respective customer, the transaction data that includes the account identification for the respective customer, and previous determinations of whether the particular customer performed the particular action at prior particular points in time during the defined time period. For instance, if a customer typically frequents a store once every weekend, a probability that a customer visits the store on Sunday could vary drastically based on whether the customer visits the store on the prior day (i.e., the immediately preceding Saturday). Keeping a static 50% probability for each day may result in numerous instances where a customer either visits the store twice in a weekend or not at all in a weekend, altering the results of the simulation. In this basic example, the probabilities may be adjusted to account for the customer maintaining the likely once-per-weekend segment.

Analysis module 220 may develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions. The assumption profile may include each of the initial values for the one or more dynamic assumptions and each of the future value curves for the one or more dynamic assumptions. In some instances, the one or more input parameters for the engagement program are received as an indication of user input. The engagement program may be any one of a new engagement program, a current engagement program, or an adjusted engagement program

In generating the future value curve for each dynamic assumption, analysis module 220 may simulate, based on the initial value for the respective dynamic assumption, a first decision point of whether the respective customer will perform a particular action at a first point in time in the defined time period. Analysis module 220 may then, for each subsequent point in time to the first point in time during the defined time period, calculate an updated value for the respective point in time based at least in part on based at least in part on the customer data for the respective customer, the transaction data that includes the account identification for the respective customer, the one or more input parameters for the engagement program, and the decision point of whether the respective customer will perform the particular action at the point in time previous to the respective point in time (e.g., the previous day, the previous week, etc.). Analysis module 220 may then simulate, based on the updated value for the respective point in time, a next decision point of whether the respective customer will perform the particular action at the respective point in time in the defined time period, using that decision point for assisting in determining the following point in time's decision point. This may be done, in some examples, using a predictive model.

In some instances, customers may be assigned to certain groups of multiple customers that all have similar behavior to reduce certain calculations, thereby increasing the efficiency of computing device 210 even further. In such instances, certain strings of predictions may cause a customer's behavior to change such that their new behavior places them in a different group. In such instances, analysis module 220 may, at a second point in time during the defined time period, change the member group for the respective customer based on the decision points for the respective customer through the second point in time.

Analysis module 220 may develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period. The forecasted consumer profile may be a predicted pattern of behavior for the respective customer with the engagement program defined by the one or more input parameters.

Analysis module 220 may then calculate, based at least in part on the forecasted consumer profile for each of the plurality of customers, an engagement program forecast for the engagement program. The engagement program forecast may include any one or more of a store traffic prediction, a profit prediction, a transaction number prediction, a reward redemption prediction, and an incremental spend prediction.

In some instances, to further improve the efficiency of computing device 210 in executing the loyalty forecast simulation, analysis module 220 may execute a script to traverse the transaction data.

In some instances, forecasted profiles for customers may ultimately be grouped into hyper-segments based on similarity. For example, analysis module 220 may compare a first forecasted consumer profile for a first customer and a second forecasted consumer profile for a second customer. Analysis module 220 may then combine the first forecasted consumer profile and the second forecasted consumer profile into a first hyper segment in response to determining that the first forecasted consumer profile and the second forecasted consumer profile are similar, such as if the profiles include same or similar (e.g., within 5-10%) information for a certain threshold (e.g., 75%, 80%, 90%, 95%, etc.) of the forecasted profile.

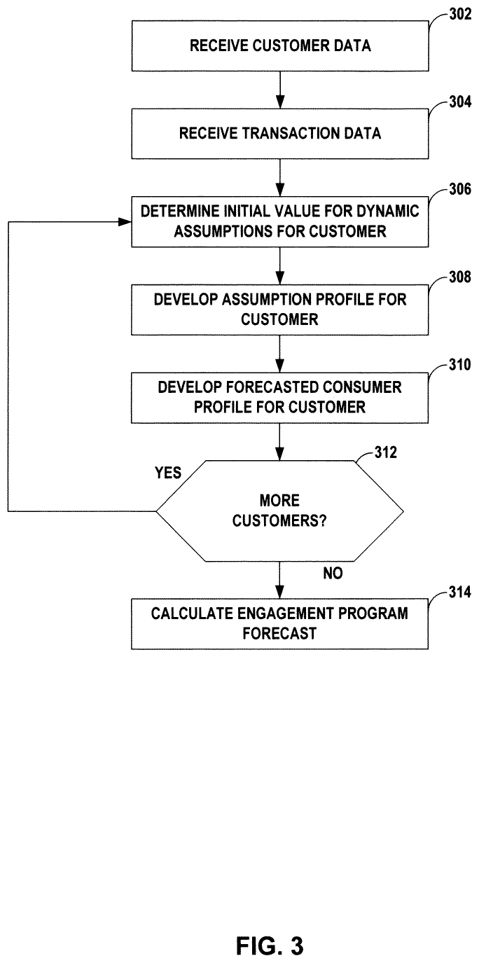

FIG. 3 is a flow chart illustrating an example mode of operation. The techniques of FIG. 3 may be performed by one or more processors of a computing device, such as system 100 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques described herein, communication module 222 receives, for a consumer store, customer data for each of a plurality of customers, the customer data including at least an account identification for each respective customer and consumer behavior data for each respective customer (302). Communication module 222 receives transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction (304).

Analysis module 220 may execute, based at least in part on the customer data and the transaction data, a loyalty forecast simulation for an engagement program for the consumer store by, for each of the plurality of customers, determining, based at least in part on the customer data for the respective customer and the transaction data that includes the account identification for the respective customer, an initial value for each of one or more dynamic assumptions for the respective customer (306). Analysis module develops, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value, curves for the one or more dynamic assumptions (308). Analysis module 220 develops, based at least in part on the one or more input parameters for the engagement program, the customer data for the respective customer, the transaction data that includes the account identification for the respective customer, and the assumption profile for the respective customer, a forecasted consumer profile for the respective customer over the defined time period (310). If there are more customers to analyze (“YES” branch of 312), analysis module returns to step 306 to determine an initial value for dynamic assumptions for a new customer.

If analysis module 220 has completed the analysis for each customer (“NO” branch of 312), analysis module 220 calculates, based at least in part on the forecasted consumer profile for each of the plurality of customers, an engagement program forecast for the engagement program (314).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by one or more processors and for a consumer store, customer data for each of a plurality of customers, the customer data including at least an account identification for each respective customer and consumer behavior data for each respective customer;
receiving, by the one or more processors, transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction;
executing, by the one or more processors and based at least in part on the customer data and the transaction data, a loyalty forecast simulation for an engagement program for the consumer store by:
for each of the plurality of customers:
determining, by the one or more processors and based at least in part on the customer data for the respective customer and the transaction data that includes the account identification for the respective customer, an initial value for each of one or more dynamic assumptions for the respective customer;
developing, by the one or more processors and based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions; and
developing, by the one or more processors and based at least in part on the one or more input parameters for the engagement program, the customer data for the respective customer, the transaction data that includes the account identification for the respective customer, and the assumption profile for the respective customer, a forecasted consumer profile for the respective customer over the defined time period; and
calculating, by the one or more processors and based at least in part on the forecasted consumer profile for each of the plurality of customers, an engagement program forecast for the engagement program.

2. The method of claim 1, further comprising:
receiving, by the one or more processors, an indication of user input that includes the one or more input parameters for the engagement program.

3. The method of claim 1, wherein the consumer behavior comprises one or more of a frequency that the customer shops at the consumer store, an amount that the customer spends at the consumer store, a time of year that the customer shops at the consumer store, newsletter subscription information, and department preferences within the consumer store.

4. The method of claim 1, wherein the loyalty data comprises one or more of a percentage of the transactions where a loyalty identification was used by the customer, a frequency of the user redeeming an engagement program redeemable during a transaction, a percentage of redeemables that expire while unredeemed, an amount of a redeemable redeemed per transaction on average, a total number of transactions where the loyalty identification was used by the customer, a total number of transactions where the user redeemed an engagement program redeemable, a total number of redeemables that expire while unredeemed, a total amount of redeemables redeemed for the customer, a probability of the customer redeeming a redeemable during any given transaction, a probability of the customer converting engagement rewards into a redeemable, a probability of the customer to incrementally transact to redeem a redeemable, a probability of the customer to incrementally transact after redeeming a redeemable, an incremental spend associated with redeeming a redeemable, and an incremental spend associated with a next transaction after redeeming a redeemable.

5. The method of claim 1, wherein each of the one or more dynamic assumptions comprise a probability that a particular customer will perform a particular action at a particular point in time during the defined time period based at least in part on the customer data for the respective customer, the transaction data that includes the account identification for the respective customer, and previous determinations of whether the particular customer performed the particular action at prior particular points in time during the defined time period.

6. The method of claim 1, wherein generating the future value curve for each dynamic assumption comprises:
simulating, by the one or more processors and based on the initial value for the respective dynamic assumption, a first decision point of whether the respective customer will perform a particular action at a first point in time in the defined time period; and
for each subsequent point in time to the first point in time during the defined time period:
calculating, by the one or more processors, an updated value for the respective point in time based at least in part on based at least in part on the customer data for the respective customer, the transaction data that includes the account identification for the respective customer, the one or more input parameters for the engagement program, and the decision point of whether the respective customer will perform the particular action at the point in time previous to the respective point in time; and
simulating, by the one or more processors and based on the updated value for the respective point in time, a next decision point of whether the respective customer will perform the particular action at the respective point in time in the defined time period.

7. The method of claim 6, wherein simulating the first decision point and each next decision point is further based on a predictive model.

8. The method of claim 6, wherein each of the plurality of customers belongs to one of a plurality of member groups, and wherein the method further comprises:
at a second point in time during the defined time period, changing, by the one or more processors, the member group for the respective customer based on the decision points for the respective customer through the second point in time.

9. The method of claim 1, wherein the engagement program forecast comprises one or more of a store traffic prediction, a profit prediction, a transaction number prediction, a reward redemption prediction, and an incremental spend prediction.

10. The method of claim 1, wherein the forecasted consumer profile comprises a predicted pattern of behavior for the respective customer with the engagement program defined by the one or more input parameters.

11. The method of claim 1, wherein the engagement program comprises one of a new engagement program, a current engagement program, or an adjusted engagement program.

12. The method of claim 1, further comprising executing, by the one or more processors, a script to traverse the transaction data.

13. The method of claim 1, wherein the transaction data comprises data regarding each individual transaction with each individual customer that is processed at the consumer store.

14. The method of claim 1, further comprising:
comparing, by the one or more processors, a first forecasted consumer profile for a first customer and a second forecasted consumer profile for a second customer; and
combining, by the one or more processors, the first forecasted consumer profile and the second forecasted consumer profile into a first hyper segment in response to determining that the first forecasted consumer profile and the second forecasted consumer profile are similar.

15. A computing device for a consumer store, the computing device comprising one or more processors configured to:
receive customer data for each of a plurality of customers, the customer data including at least an account identification for each respective customer and consumer behavior data for each respective customer;
receive transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction;
execute, based at least in part on the customer data and the transaction data, a loyalty forecast simulation for an engagement program for the consumer store by:
for each of the plurality of customers:
determine, based at least in part on the customer data for the respective customer and the transaction data that includes the account identification for the respective customer, an initial value for each of one or more dynamic assumptions for the respective customer;
develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions; and
develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period; and
calculate, based at least in part on the forecasted consumer profile for each of the plurality of customers, an engagement program forecast for the engagement program.

16. The computing device of claim 15, wherein the consumer behavior comprises one or more of a frequency that the customer shops at the consumer store, an amount that the customer spends at the consumer store, a time of year that the customer shops at the consumer store, newsletter subscription information, and department preferences within the consumer store.

17. The computing device of claim 15, wherein the loyalty data comprises one or more of a percentage of the transactions where a loyalty identification was used by the customer, a frequency of the user redeeming an engagement program redeemable during a transaction, a percentage of redeemables that expire while unredeemed, an amount of a redeemable redeemed per transaction on average, a total number of transactions where the loyalty identification was used by the customer, a total number of transactions where the user redeemed an engagement program redeemable, a total number of redeemables that expire while unredeemed, a total amount of redeemables redeemed for the customer, a probability of the customer redeeming a redeemable during any given transaction, a probability of the customer converting engagement rewards into a redeemable, a probability of the customer to incrementally transact to redeem a redeemable, a probability of the customer to incrementally transact after redeeming a redeemable, an incremental spend associated with redeeming a redeemable, and an incremental spend associated with a next transaction after redeeming a redeemable.

18. The computing device of claim 15, wherein each of the one or more dynamic assumptions comprise a probability that a particular customer will perform a particular action at a particular point in time during the defined time period based at least in part on the customer data for the respective customer, the transaction data that includes the account identification for the respective customer, and previous determinations of whether the particular customer performed the particular action at prior particular points in time during the defined time period.

19. The computing device of claim 15, wherein the one or more processors being configured to generate the future value curve for each dynamic assumption comprises the one or more processors being configured to:
simulate, based on the initial value for the respective dynamic assumption, a first decision point of whether the respective customer will perform a particular action at a first point in time in the defined time period; and
for each subsequent point in time to the first point in time during the defined time period:
calculate an updated value for the respective point in time based at least in part on based at least in part on the customer data for the respective customer, the transaction data that includes the account identification for the respective customer, the one or more input parameters for the engagement program, and the decision point of whether the respective customer will perform the particular action at the point in time previous to the respective point in time; and
simulate, based on the updated value for the respective point in time, a next decision point of whether the respective customer will perform the particular action at the respective point in time in the defined time period.

20. A non-transitory computer-readable storage medium having stored thereon instructions that, when executed, cause one or more processors of a computing device for a consumer store to:
receive customer data for each of a plurality of customers, the customer data including at least an account identification for each respective customer and consumer behavior data for each respective customer;
receive transaction data for each of a plurality of transactions, the transaction data including at least a transaction amount for the respective transaction, the account identification for the customer of the plurality of customers that completed the transaction, and loyalty data indicating how the customer used engagement program benefits for the respective transaction;
execute, based at least in part on the customer data and the transaction data, a loyalty forecast simulation for an engagement program for the consumer store by:
for each of the plurality of customers:
determine, based at least in part on the customer data for the respective customer and the transaction data that includes the account identification for the respective customer, an initial value for each of one or more dynamic assumptions for the respective customer;
develop, based at least in part on the customer data for the respective customer, the transaction data that includes the account identification for the respective customer, one or more input parameters for the engagement program, and the initial values for the one or more dynamic assumptions, an assumption profile for the respective customer by, over a defined time period for the loyalty forecast simulation, adjusting the initial value for each of the one or more dynamic assumptions to generate a future value curve for each of the one or more dynamic assumptions, the assumption profile comprising each of the initial values for the one or more dynamic assumptions and each of the future value curves for the one or more dynamic assumptions; and
develop, based at least in part on the one or more input parameters for the engagement program, the customer data for the respective customer, the transaction data that includes the account identification for the respective customer, and the assumption profile for the respective customer, a forecasted consumer profile for the respective customer over the defined time period; and
calculate, based at least in part on the forecasted consumer profile for each of the plurality of customers, an engagement program forecast for the engagement program.
